(19) United States
(12) Patent Application Publication
(10) Pub. No.: US 2007/0248191 A1
(43) Pub. Date: Oct. 25, 2007

(54) Baseband sample selection

(75) Inventor: Jan Pettersson, Jarfalla (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (publ), Stockholm (SE)

(21) Appl. No.: 11/410,281

(22) Filed: Apr. 25, 2006

(51) Int. Cl. H04L 27/06; H04B 1/707; H04L 1/02

(52) U.S. Cl. 375/340; 375/347; 375/148

(57) ABSTRACT

A receiver receives a signal and samples it at multiple sample points. During a first time interval, a first subset of the multiple sample points are selected for further receiver processing. During a second time interval, a second different subset of the multiple sample points are selected for further receiver processing. Alternatively, the sampling positions for sampling the received signal may be automatically varied so that the sampling positions change in subsequent time intervals. The subsets may be alternately selected or varied, randomly selected or varied, or selected or varied in some other fashion. Some of sample points provide more optimal samples for the received signal, and some provide less optimal samples. Having different sample points processed at different times improves receiver stability and performance.

### TECHNICAL FIELD

The technical field relates to communications, and more particularly, to sampling a received signal. One example application is to cellular communications systems.

### BACKGROUND

A rake receiver is a radio receiver designed to counter the effects of multi-path fading. Multi-path fading refers to the same transmitted radio signal taking two or more paths from the transmitter to the receiver because the transmitted signal is reflected off buildings or other obstructions. The reflected signal paths are longer than a direct signal path that is not reflected. The direct signal path is received first and reflected signal paths are received at a later time delayed from receipt of the direct signal.

A rake receiver uses several “sub-receivers” or receiving branches each delayed slightly in order to tune in to the individual multi-path components. Each component is decoded independently, but at a later stage combined in order to make the most use of the different transmission characteristics of each transmission path. This could very well result in higher SNR (or Eb/No) in a multi-path environment than in a “clean” environment.

The rake receiver is so named because of its analogous function to a garden rake, each branch collecting bit or symbol energy similarly to how tines on a rake collect leaves. Rake receivers are common in a wide variety of radio devices including cellular communications and wireless LAN.

FIG. 1 shows an example of multi-path fading and a rake receiver. A radio transmitter 10 transmits a signal which follows, in the simplified illustration, three different paths P1, P2, and P3. Path P1 reflects off a building before being received and demodulated in a first receiving branch 14a (receiving branches are sometimes called rake fingers) in the radio receiver 12. Direct path P2 suffers no reflection delay and is received and demodulated in a second receiving branch 14b. A third path P3 is reflected off a tree and then received in a third receiving branch 14c. The demodulated outputs of the three receiving branches are combined in combiner 16 using a signal combining technique such as, for example, maximum ratio combining (MRC).

Many modern base stations are divided into a radio part and a baseband processing part. The radio part performs the transceiving, filtering, amplifying, and frequency converting operations, while the baseband processing part performs operations such as modulation/demodulation, coding/decoding, interleaving/de-interleaving, equalization, etc. The radio part and baseband processing part are typically coupled by a communications link, e.g., a dedicated optical link. When there are multiple radio units, separate dedicated links connect each radio unit to the baseband unit. Assuming the links are optical, each optical link includes one optical fiber for carrying digital information downlink from the baseband unit to the radio unit and another optical fiber for carrying digital information uplink from the radio unit to the baseband unit. The baseband processing part typically includes a rake receiver as described above. Each receiver branch samples the received signal, and for most modern wireless systems in which complex data is transmitted, each receiving branch samples both real (I) and imaginary (Q) data streams for each received signal. In most digital communications systems, a large number of samples usually must be taken, transmitted over the link between the radio part and baseband part and processed in the baseband part.

FIG. 2 is a function block diagram that illustrates a receiving branch 14 corresponding to a radio part. The receiving branch includes an antenna 18 which provides a received signal to an RF down converter 20 which filters, amplifies, and frequency downconverts the RF signal to baseband. The baseband signal is provided to an analog to digital converter 22 (or other sampling device) which converts the signal into digital samples. The analog-to-digital converter 22 operates in accordance with a particular sampling frequency represented in the figure as a clock. Typically, the sampling frequency is fixed.

FIG. 3 illustrates three multi-path signals, corresponding to the three multi-path example illustrated in FIG. 1, that need to be sampled. One symbol S1 is shown as a regular thickness line. A second symbol S2 is shown as a dotted line. A third symbol S3 is shown as a thicker line. At the fixed sampling rate, each symbol in each sample is sampled four times. Eight sampling points are shown which cover the three different path symbols S1-S3. The arrows represent the ideal decision points for sampling each path symbol, i.e., at the peak of the symbol waveform. In this example, the path symbols are over-sampled four times in order for the demodulation to be performed successfully.

If the sampling could be reliably performed exactly at the decision point for each symbol, only one sample would be necessary for accurate demodulation, rather than four samples. Each symbol has its maximum energy at the ideal decision point. Sampling at some point in the symbol waveform other than the ideal decision point reduces the symbol energy, and thus, the performance of the receiver.

There are many practical reasons why the sampling point cannot be changed to align with the optimal decision point, particularly where there are many different signals to be processed. For example, a base station receiver must process and sample signals received from multiple mobile stations. Perhaps a 100 mobile station signals might be processed in one base station baseband processor, and each mobile connection may have several multi-path symbols as well. In other words, an optimum sampling point for one mobile radio communication might be extremely poor for another mobile communication signal. The same is true for a rake receiver receiving multi-paths for a single radio communication: one sampling point may be optimum for one rake finger and suboptimum for all the other rake fingers. Consequently, it is just not practical for the base station to have determine and switch to different ideal sampling points for each mobile communication as well as different ideal sampling points for each multi-path signal associated with an individual mobile communication.

An alternative is to significantly over-sample the received signals so that an average can be taken. But as mentioned above, this over-sampling increases the amount of data that must be transmitted over the link between the radio and baseband parts as well as the amount of sample data that must be processed by the baseband part.

Exacerbating these problems is the fact that available simulation software for testing sampling accuracy/position assumes optimum symbol clock timing. But as explained above, this assumption is not reasonable. Despite all of these problems, it would still be desirable to increase the accuracy of the sampling process without having to rely too heavily or at all on over sampling.

### SUMMARY

A receiver receives a signal and samples it at multiple sample points. During a first time interval, a first subset of the multiple sample points is selected or otherwise provided for further receiver processing. During a second time interval, a second different subset of the multiple sample points is selected or otherwise provided for further receiver processing. Alternatively, the sampling positions for sampling the received signal may be automatically varied so that the sampling positions change in subsequent time intervals. The subsets may be alternately selected or varied, randomly selected or varied, or selected or varied in some other fashion. Some of sample points in the first subset provide more optimal samples for the received signal, and some of the sample points in the first subset provide less optimal samples for the received signal. Likewise, some of the samples in the second subset provide more optimal samples for the received signal, and some of the samples in the second subset provide less optimal samples for the received signal.

In a radio communications environment, a signal is received at least first and second receiving branches of a radio receiver. The signal in the first receiving branch is sampled during a first time interval thereby generating a first sequence of samples. The signal at the second receiving branch is sampled during the first time interval thereby generating a second sequence of sample points different from the first sequence of sample points. The first and second sequence of sample points are provided to a processor for processing and then subsequent decoding. The sampling points in the first and second receiving branches may be the same, but in that case they are used at different times or in a different sequence. Preferably, but not necessarily, the first time interval may be a transmission time interval or a fraction of a transmission time interval.

Having different sample points processed at different times or at different receive branches improves receiver stability and performance when the receiver is not designed to optimize the sampling positions for any one received signal. For multiple signals, more accurate sampling is obtained on average to enhance receiver stability. When samples for a received signal come from different positions in time and/or space, the number of samples needed for accurate demodulation and decoding can be reduced by one half, thereby providing enhanced performance. In the context of a distributed radio base station having a radio part and baseband part configured for rake reception, less data needs to be sent over the link between the radio part and the baseband part and less sample data needs to be processed. In fact, this approach may improve sampling accuracy overall so that only one fourth the typical number of samples is needed, which is a tremendous reduction in the amount of data to be transported between the radio part and the baseband part and processed in the baseband part.

### BRIEF DESCRIPTION OF THE FIGURES

FIG. 1 is a diagram illustrating multi-path transmission and reception;

FIG. 2 is a simplified function block diagram of a rake receiving branch;

FIG. 3 is a graph showing multi-path signals being sampled;

FIG. 4 is a flow chart diagram illustrating example procedures for varying sampling in accordance with one non-limiting approach;

FIG. 5 is a flow chart diagram illustrating example procedures for varying sampling in accordance with another non-limiting approach; and

FIG. 6 is a function block diagram showing a non-limiting application to a distributed radio base station that includes a rake receiver.

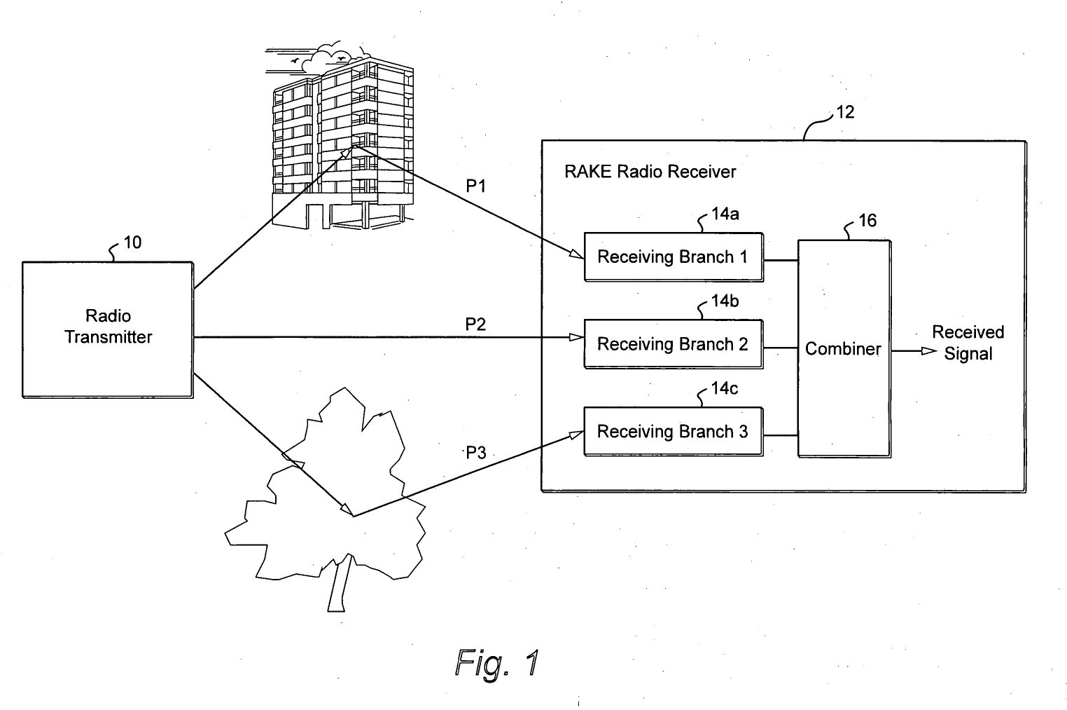

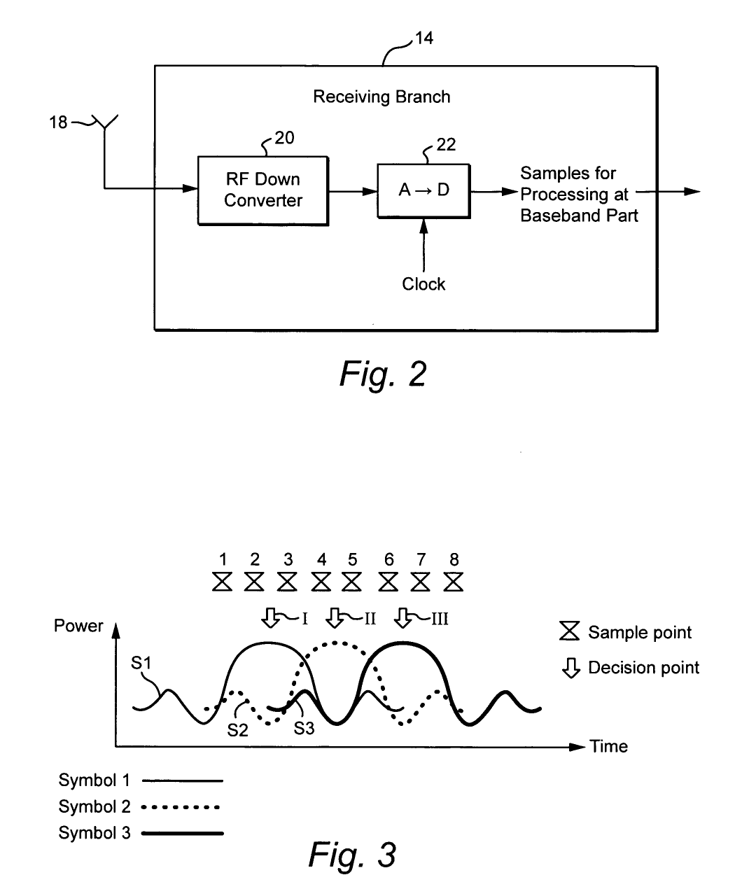

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), field programmable gate arrays, one or more digital signal processors (DSPs), etc.

Given the problems with simply selecting the optimum sample position for every one of the multiple received signals, the inventor determined that sampling accuracy at a fixed sampling rate for various received signals could be achieved by varying over time where samples are taken. As a result, some samples during one time period are more optimum for some received signals/received signal paths and less optimum for other received signals/paths. On the other hand, when the sampling positions have been varied, some of those signals/paths that were sub-optimally sampled will be sampled more accurately. Likewise, some of the previous signals that were optimally sampled may be less optimally sampled. But over time, the inventor determined that this variation in sampling position improved sampling accuracy and receiver performance.

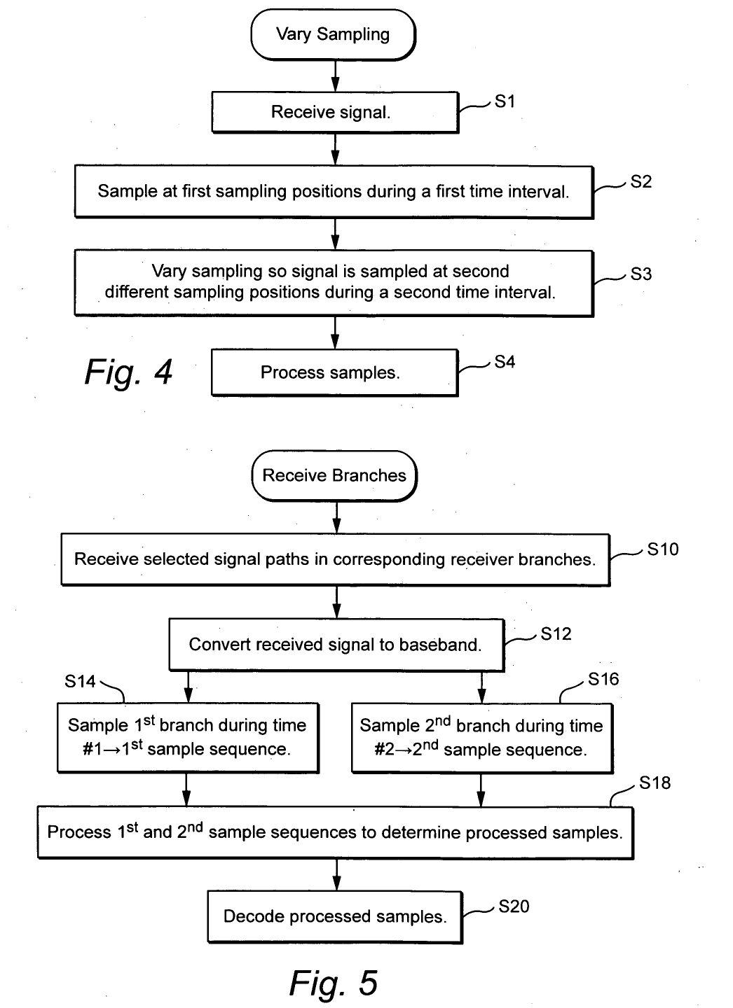

Reference is made to the “Vary Sampling” flowchart in FIG. 4 illustrating non-limiting, example procedures for varying the sampling of received signals. A signal is received (step S1) and sampled at first sampling positions during a first-time interval (step S2). At the end of the first-time interval, the sampling is varied so that the received signal is sampled at second different sampling positions during a second time interval (step S3). The samples are then processed as usual (step S4).

The sampling may be varied in any suitable fashion. The following are just a few examples. One way is to vary the sampling positions randomly at each different time interval. Alternatively, the sampling positions may be varied in a periodic fashion. A third way is to over-sample the received signal but then only select a subset of those samples for actual processing. The subset of samples selected could then be varied at each different time interval, again, randomly, periodically, or following some kind of pattern. Another sampling variance approach is to interpolate between sample points and select different interpolated sample points in different time intervals or select different combinations of actual and interpolated sample points in different time periods.

Yet another approach to varying sampling position may be employed when there are multiple receive branches, such as in a rake receiver or in a diversity receiver. Reference is made to the “Receive Branches” flowchart illustrating non-limiting example procedures for this approach. Initially, selected signal paths are received in a corresponding receiver branch (step S10). Each receiver branch converts its received signal from RF to baseband frequency (step S12). The first branch sampler samples its received signal during a first time period to produce a first sequence of samples (step S14). Using the same sampling frequency, the second receiver branch sampler samples its received signal at a different time to generate a second sample sequence (step S16). The first and second sample sequences are processed, e.g., averaged, ratio combined, selected, etc. to determine the actual samples to be used for subsequent processing (step S18). For example, subsequent processing might include decoding the processed samples (step S20).

Consider the following simple example of selecting different samples for two different receiver branches. Assume that the received signal is over-sampled four times in each receiver processing branch so that the following sample sequences available in the radio part: 1 2 3 4 1 2 3 4 1 2 3 4 . . . . In the first receiving branch, only alternating samples 2 and 4 might be sent, while on the second receiving branch only adjacent samples 1 and 3 might be sent. Alternatively, the radio part might average two samples to provide an average sample per symbol, and the second receiving branch might average different samples (e.g., 1 an 4) to provide another average per symbol.

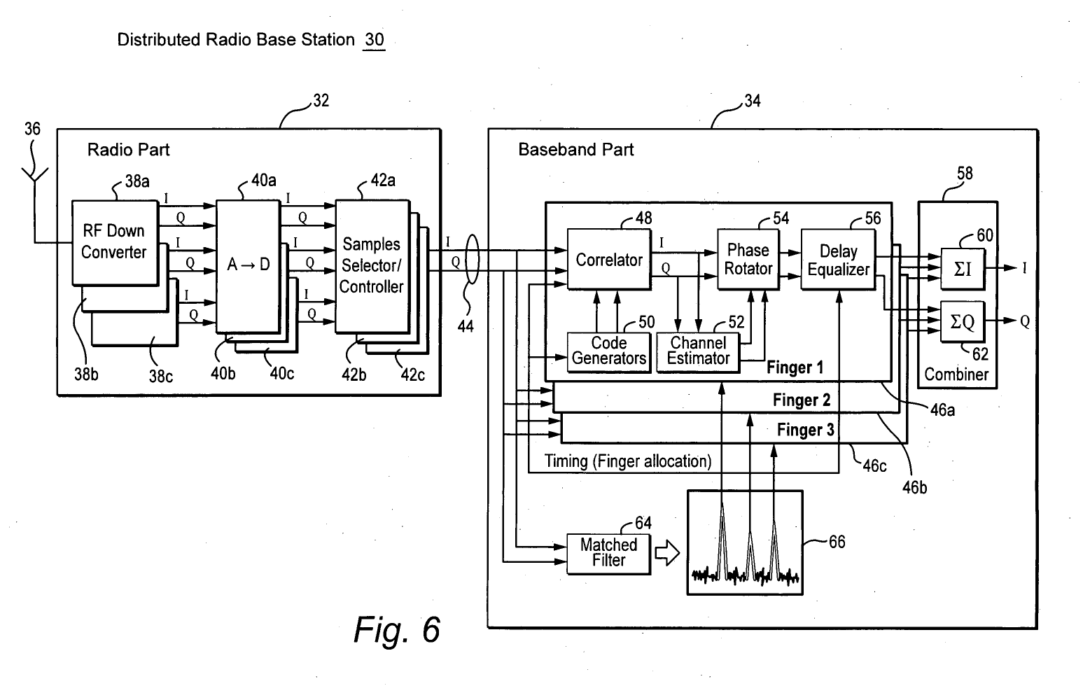

Although the variable sampling technique described may be applied to any receiver, one advantageous example application is to a radio base station, and in particular, to a distributed radio base station. FIG. 6 illustrates a distributed base station 30 that includes a radio part 32 coupled to a baseband part 34 by way of a suitable communications link 44. The radio part includes one or more antennas 36 which provide multi-path signals to an RF downconverter 38. For purposes of this example, three multi-paths are assumed, and thus, there is an associated RF down converter 38a, 38b, and 38c in each of the three receiver branches a, b, and c. The received signals are complex and include real (I) and imaginary (Q) data streams. Each receiver branch includes an analog-to-digital converter or other sampling device 40a, 40b, and 40c. Each sampling device samples the real and imaginary data streams in its branch and provides those real and imaginary samples to a sample selector/controller 42a, 42b, and 42c, respectively. Each sample selector/controller implements a sample varying scheme, some examples of which were described above. Of course, sample varying schemes other than those described above may be employed.

The I and Q samples received from each receiver branch in the radio part 32 are processed in corresponding fingers 46a, 46b, and 46c in the baseband part 34. For this example, it is assumed that the radio communications employ Code Division Multiple Access (CDMA) or wideband CDMA (WCDMA). Accordingly, a code generator 50 and a correlator 48 in each finger 46 perform despreading and integration to user data symbols for each of the I and Q channels. A channel estimator 52 uses pilot symbols for estimating the channel state which will then be removed by the phase rotator 54 from the received signals. The multi-path delay is compensated for the difference in the arrival times of the symbols in each rake finger in the delay equalizer 56. The rake combiner 58 includes a combiner for each of the real and imaginary symbol streams from each finger. Each combiner then sums the channel compensated symbols using the appropriate combining techniques such as maximum ratio combining, etc. to produce the demodulated symbol streams I and Q. Also shown is a matched filter 64 used for determining and updating the current multi-path delay profile of the radio channel. The measured and possibly averaged multi-path delay profile 66 is then used to assign the rake finger to the largest peaks.

The length of the time interval or the rate at which the sampling points or sampling point selections are varied depends on the application. In the distributed radio base station 30 shown in FIG. 6, one example, non-limiting time frame might be one transmission time interval (TTI) or less. One possible transmission time interval value is ten milliseconds, but other values could be employed as well. For example, one time interval may be one spread bit, one slot, one radio frame or one message depending on the implementation. In one example implementation, one time interval may include an equal number of lagging and leading baseband samples. Preferably, the time interval may be selected to not disturb algorithms in the baseband part 34.

Thus, in contrast to the aim of traditional sampling in which sampling “jitter” and sampling “wander” are undesirable and are attempted to be eliminated, the inventor realized that by purposely introducing a jitter of sorts into the sampling process, unexpected and advantageous results were achieved. Varying the sampling position of samples fed into the baseband processing unit evens out differences in timing and provides improved and more consistent receiver performance. Variations in receiver performance require more transmit power to transmit over the air interface which is undesirable for many reasons. One particularly advantageous application is when a mobile terminal is in soft handover, and individualized sampling points for all receiving handover legs and rake fingers cannot be used. But the invention has wide application to any sampling situation.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A method for use in a receiver, comprising:
receiving a signal;
sampling the received signal at multiple sample points;
during a first time interval, providing a first subset of the multiple samples from a first subset of sample points for further processing; and
during a second time interval, providing a second different subset of the multiple samples from a second subset of sample points different from the first subset of sample points for further processing.

2. The method in claim 1, wherein the subsets change periodically or randomly.

3. The method in claim 1 for use in radio communications, wherein the first time interval is a transmission time interval or a fraction of a transmission time interval.

4. The method in claim 1, wherein some of samples in the first subset are more optimal samples for the received signal, some of the samples in the first subset are less optimal samples for the received signal, some of the samples in the second subset are more optimal samples for the received signal, and some of the samples in the second subset are less optimal samples for the received signal.

5. A method for use in a receiver, comprising:
receiving a signal;
sampling the received signal at a first series of sampling positions during a first time interval; and
automatically varying the sampling positions for sampling the received signal so that the sampling positions change in subsequent time intervals.

6. The method in claim 5, further comprising:
varying the sampling positions periodically or randomly.

7. The method in claim 5, further comprising:
varying the sampling positions by selecting different sample positions.

8. The method in claim 5, further comprising:
calculating intermediate sample values between adjacent ones of the sampling positions and using some of the interpolated sample values.

9. The method in claim 5 for use in radio communications, wherein the first time interval is a transmission time interval or a fraction of a transmission time interval.

10. The method in claim 5, wherein some of the first series of sampling positions are more optimal for sampling the received signal, some of the sampling positions are less optimal for sampling the received signal, some of the changed sampling positions are more optimal for sampling the received signal, and some of the changed sampling positions are less optimal for sampling the received signal.

11. A method for use in a radio receiver, comprising:
receiving a signal at a first receiving branch;
sampling the signal in the first receiving branch during a first time interval and obtaining a first sequence of samples;
providing the first sequence of samples to processing circuitry;
receiving the signal at a second receiving branch;
sampling the signal in the second receiving branch during the first time interval and obtaining a second sequence of sample points different from the first sequence of sample points; and
providing the second sequence of sample points to the processing circuitry.

12. The method in claim 11, further comprising:
the processing circuitry processing the first and second sequences of sampling points to determine processed samples and decoding the processed samples.

13. The method in claim 11, wherein the sampling points in the first and second receiving branches are the same but are used at different times or in a different sequence.

14. Apparatus for use in a receiver, comprising:
a sampler for sampling a received signal at multiple sample points, and
a controller for providing a first subset of the multiple samples from a first subset of sample points for further processing during a first time interval, and providing a second different subset of the multiple samples from a second subset of sample points different from the first subset of sample points for further processing during a second time interval.

15. The apparatus in claim 14, wherein the controller is configured to change the subsets periodically or randomly.

16. The apparatus in claim 14, wherein the first time interval is a radio transmission time interval or a fraction of a radio transmission time interval.

17. The apparatus in claim 14, wherein some of samples in the first subset are more optimal samples for the received signal, some of the samples in the first subset are less optimal samples for the received signal, some of the samples in the second subset are more optimal samples for the received signal, and some of the samples in the second subset are less optimal samples for the received signal.

18. The apparatus in claim 14 incorporated into a radio part of a base station or a mobile station.

19. Apparatus for use in a receiver, comprising:
a sampler for sampling a received analog signal at a first series of sampling positions during a first time interval to generate a digital signal, and
a controller for varying the sampling positions for sampling the received signal so that the sampling positions change in subsequent time intervals.

20. The apparatus in claim 19, wherein the controller is configured to vary the sampling positions of the sampler periodically or randomly.

21. The apparatus in claim 19, wherein the controller is configured to vary the sampling positions of the analog to digital converter by selecting different sample positions.

22. The apparatus in claim 19 for use in radio communications, wherein the first time interval is a radio transmission time interval or a fraction of a radio transmission time interval.

23. The apparatus in claim 19, wherein some of the first series of sampling positions are more optimal for sampling the received signal, some of the sampling positions are less optimal for sampling the received signal, some of the changed sampling positions are more optimal for sampling the received signal, and some of the changed sampling positions are less optimal for sampling the received signal.

24. Apparatus for use in a radio receiver, comprising:
a first receiving branch for receiving a signal, sampling the signal in the first receiving branch during a first time interval and obtaining a first sequence of samples, and outputting the first sequence of samples; and
a second receiving branch for receiving the signal, sampling the signal in the second receiving branch during the first time interval and obtaining a second sequence of sample points different from the first sequence of sample points, and outputting providing the second sequence of sample points.

25. The apparatus in claim 24, wherein the radio transceiver is a distributed base station including a radio part coupled by a communications link to a baseband part, and wherein the apparatus is implemented in the radio part.

26. The apparatus in claim 24, further comprising processing circuitry configured to process the first and second sequences of sampling points.
